(19) United States
(12) Patent Application Publication
(10) Pub. No.: US 2026/0088859 A1
(43) Pub. Date: Mar. 26, 2026

(54) POWER-SAVING ADAPTIVE RECEIVE DIVERSITY (ARD) PROCESSES

(71) Applicant: QUALCOMM Incorporated, San Diego, CA (US)

(72) Inventors: Harish VENKATACHARI, San Jose, CA (US); Raghu Narayan CHALLA, San Diego, CA (US); Arash EBADI SHAHRIVAR, San Diego, CA (US)

(21) Appl. No.: 19/190,550

(22) Filed: Apr. 25, 2025

Related U.S. Application Data
(60) Provisional application No. 63/697,997, filed on Sep. 23, 2024.

(51) Int. Cl. H04B 7/0426

(52) U.S. Cl. CPC H04B 7/0426

(57) ABSTRACT

A wireless node may include a battery. A wireless node may include one or more memories, individually or in combination, having instructions. A wireless node may include one or more processors, individually or in combination, configured to execute the instructions to cause the apparatus to: receive signaling according to a first multiple-input multiple-output (MIMO) capability, switch from the first MIMO capability to a second MIMO capability based on a power factor; and receive, after the switch, signaling according to the second MIMO capability.

### CROSS REFERENCE TO RELATED APPLICATIONS

The present application for patent claims the benefit of U.S. Provisional Application No. 63/697,997, entitled “POWER-SAVING ADAPTIVE RECEIVE DIVERSITY (ARD) PROCESSES,” filed Sep. 23, 2024, which is assigned to the assignee hereof and expressly incorporated herein by reference in its entirety.

### BACKGROUND

### Technical Field

The present disclosure generally relates to communication systems, and more particularly, to power-saving adaptive receive diversity (ARD) processes at a wireless node.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to a wireless node configured for wireless communication, comprising: a battery, one or more memories, individually or in combination, having instructions, and one or more processors, individually or in combination, configured to execute the instructions. In some examples, the wireless node is configured to receive signaling according to a first multiple-input multiple-output (MIMO) capability. In some examples, the wireless node is configured to switch from the first MIMO capability to a second MIMO capability based on a power factor. In some examples, the wireless node is configured to receive, after the switch, signaling according to the second MIMO capability.

Aspects are directed to a method for wireless communication at an apparatus. In some examples, the method includes receiving signaling according to a first multiple-input multiple-output (MIMO) capability. In some examples, the method includes switching from the first MIMO capability to a second MIMO capability based on a power factor. In some examples, the method includes receiving, after the switch, signaling according to the second MIMO capability.

Aspects are directed to an apparatus for wireless communication. In some examples, the apparatus includes means for receiving signaling according to a first multiple-input multiple-output (MIMO) capability. In some examples, the apparatus includes means for includes switching from the first MIMO capability to a second MIMO capability based on a power factor. In some examples, the apparatus includes means for receiving, after the switch, signaling according to the second MIMO capability.

Aspects are directed to a non-transitory computer readable medium, having instructions stored thereon for performing a method for wireless communication at an apparatus. In some examples, the method includes receiving signaling according to a first multiple-input multiple-output (MIMO) capability. In some examples, the method includes switching from the first MIMO capability to a second MIMO capability based on a power factor. In some examples, the method includes receiving, after the switch, signaling according to the second MIMO capability.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a flow diagram illustrating a first example process for balancing battery performance and modem performance.

FIG. 6 is a flow diagram illustrating a second example process for balancing battery performance and modem performance.

FIG. 7 is a flow diagram illustrating a third example process for balancing battery performance and modem performance.

FIG. 8 is a flowchart of a method of wireless communication.

FIG. 9 is a diagram illustrating an example of a hardware implementation for an example apparatus.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Adaptive receive diversity (ARD) processes may relate to various functions performed at a wireless node. In some cases, an ARD process may detect long term antenna imbalance and turn off the weaker antenna if the imbalance is greater than an imbalance threshold (ThIB). Turning off the weaker antenna may improve power saving and may also improve performance. In other cases, an ARD process may detect high antenna correlations and turn off one antenna if the correlation is greater than a correlation threshold (ThHC). Such a correlation may be based on an estimate of long-term antenna correlation. An ARD process may also switch between two spatial combining linear multi-user detection (SC-LMUD) modes.

In another example, an ARD process may be configured to perform receive chain management techniques at a wireless node. In this example, the ARD process(es) may allow for an adaptive number (e.g., quantity) of active receive antenna based on network conditions and/or conditions at the wireless node. Such techniques may thus enhance communication efficiency and reduce power consumption at the wireless node, which may increase battery life.

Accordingly, aspects of the disclosure are directed to ARD process(es) that may be performed based on battery status. In some cases, a wireless node may be configured for multiple input multiple output (MIMO) communication, which includes the use multiple receive antennas at the wireless node to receive a wireless signal. B y using multiple receive antennas for wireless communication, the wireless node may experience an increase in data throughput, improved combining and decoding of received signals, and an increase in link range without the need for additional bandwidth or transmit power at the transmitting entity.

In one example, the wireless node may be implemented as a user equipment (UE). In this example, The UE may be configured to use four receive antennas at the same time for communication via a particular band. It should be noted that in some examples, the UE may be configured for using more (e.g., six antenna, eight antenna, etc.) or fewer antenna (e.g., two antenna) in a communication in support of any suitable higher order receive diversity (HORxD).

However, the use of multiple receive antenna at a wireless node may result in a higher power consumption rate over time relative to a rate of power consumption associated with a single antenna. This is because, by using multiple antenna to receive a signal, the wireless node is required to provide power to more antennas and more radio frequency (RF) parts associated with those antenna and their respective cycles in the hardware to decode the received signal. As such, although a wireless node may experience improved communication performance by using multiple receive antenna, such a performance improvement may impact a battery used to power the wireless node.

Thus, in some examples, if the wireless node stands to experience an improvement in its communication (e.g., increased spectral efficiency and/or spectral capacity, etc.) with another entity by using multiple receive antenna relative to using one or a lesser number of receive antenna, then the wireless node may increase the number of receive antenna it uses to communicate with the other entity despite any impact it may have on power consumption and battery life. However, if the wireless node does not stand to experience such an improvement or if an improvement experienced by increasing the number of receive antenna is modest (e.g., no significant change in spectral efficiency and/or capacity, no or low amount of traffic, etc.), then the wireless node may refrain from increasing the number of receive antenna it uses. This is because there would be little, or no benefit realized in exchange for increased power consumption.

As such, the battery status (e.g., amount of charge on the battery, whether the battery is currently being charged, the capacity of the battery, etc.) of the wireless node may be a factor in determining whether the wireless node can be allowed to use a particular number of receive antenna simultaneously. Thus, aspects of the disclosure are directed to determining, based on the battery status of the wireless node, a number of receive antenna that may be used for simultaneously receiving signaling by the wireless node. In other words, the tradeoff between MIMO performance and power consumption at the wireless node may be managed by ARD processing based on battery status.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

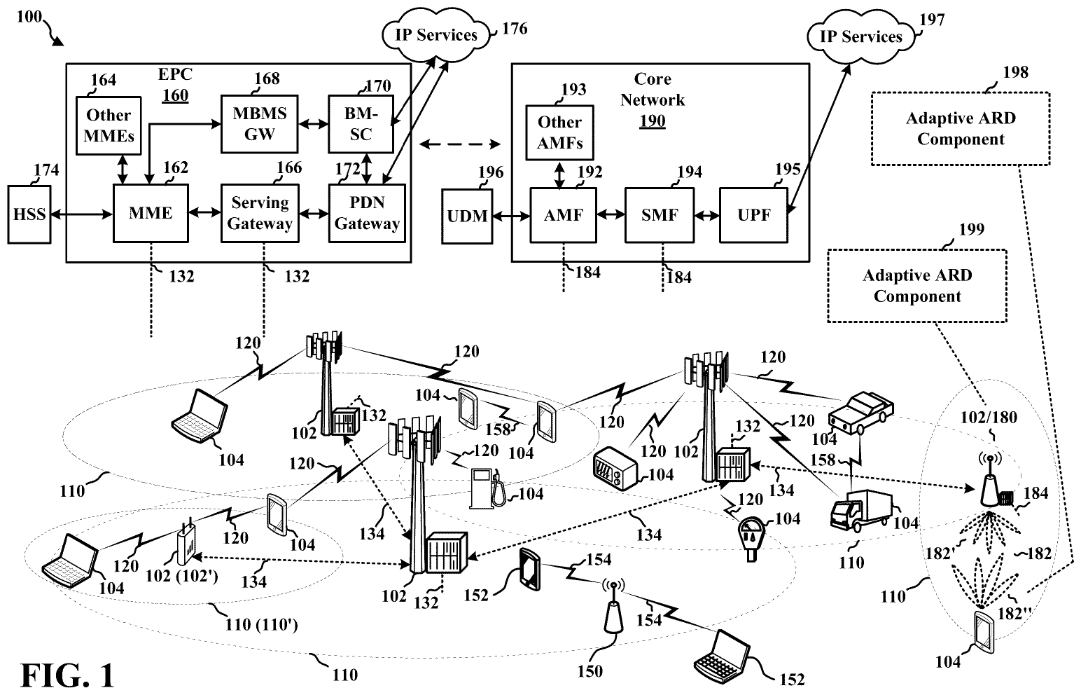

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved NodeBs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. A though a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the E H F band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UE s 104 and the EPC 160. Generally, the MME 162 provides bearer and connection management. All user Internet protocol (IP) packets are transferred through the Serving Gateway 166, which itself is connected to the PDN Gateway 172. The PD N Gateway 172 provides UE IP address allocation as well as other functions. The PD N Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLM N), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, NodeB, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 fora UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include an adaptive ARD component 198. As described in more detail elsewhere herein, the adaptive ARD component 198 may be configured to: receive signaling according to a first multiple-input multiple-output (MIMO) capability; switch from the first MIMO capability to a second MIMO capability based on a power factor; and receive, after the switch, signaling according to the second MIMO capability. Additionally, or alternatively, the adaptive ARD component 198 may perform one or more other operations described herein.

The base station 102/180 may include an adaptive ARD component 199. As described in more detail elsewhere herein, the adaptive ARD component 199 may be configured to: receive signaling according to a first multiple-input multiple-output (MIMO) capability; switch from the first MIMO capability to a second MIMO capability based on a power factor; and receive, after the switch, signaling according to the second MIMO capability. Additionally, or alternatively, the adaptive ARD component 199 may perform one or more other operations described herein.

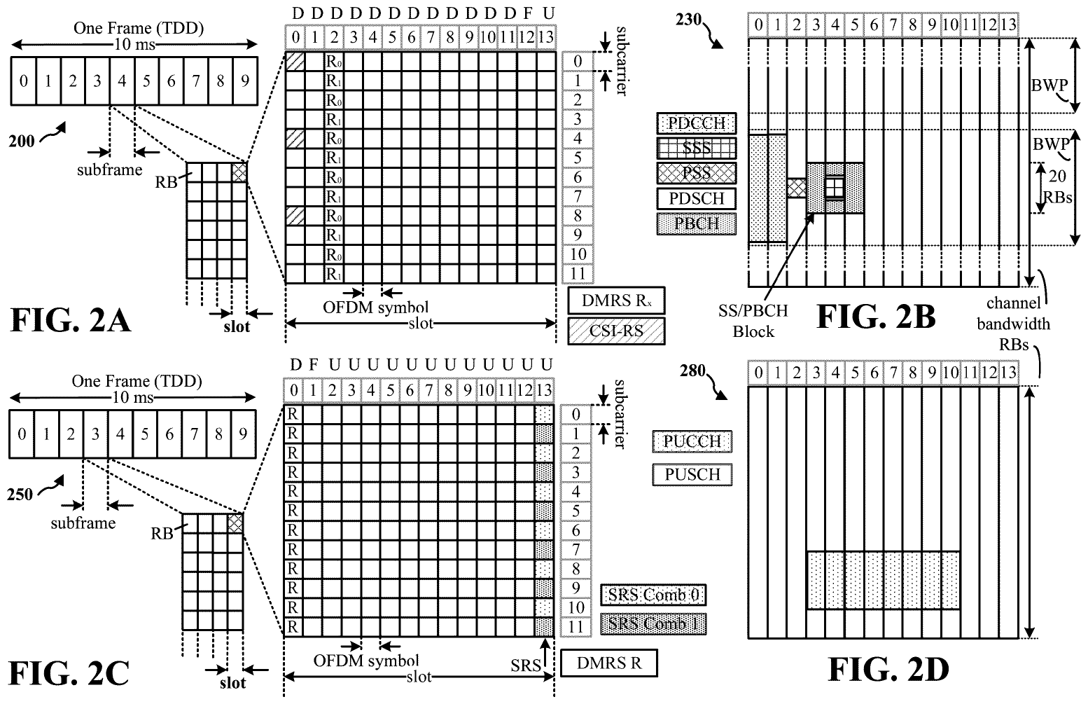

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies p 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BW P may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

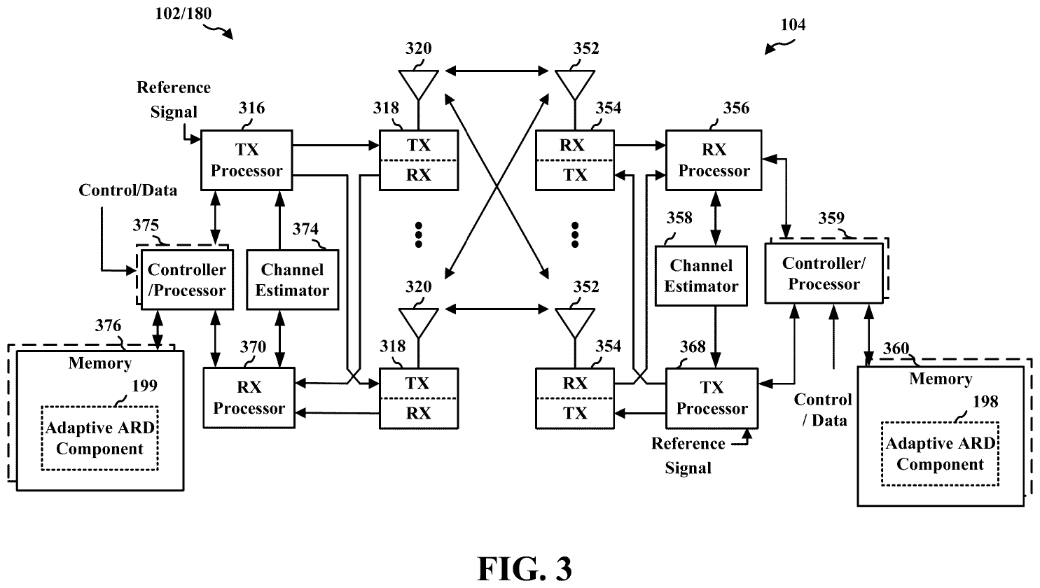

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDA P) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NA CK protocol to support H A R Q operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

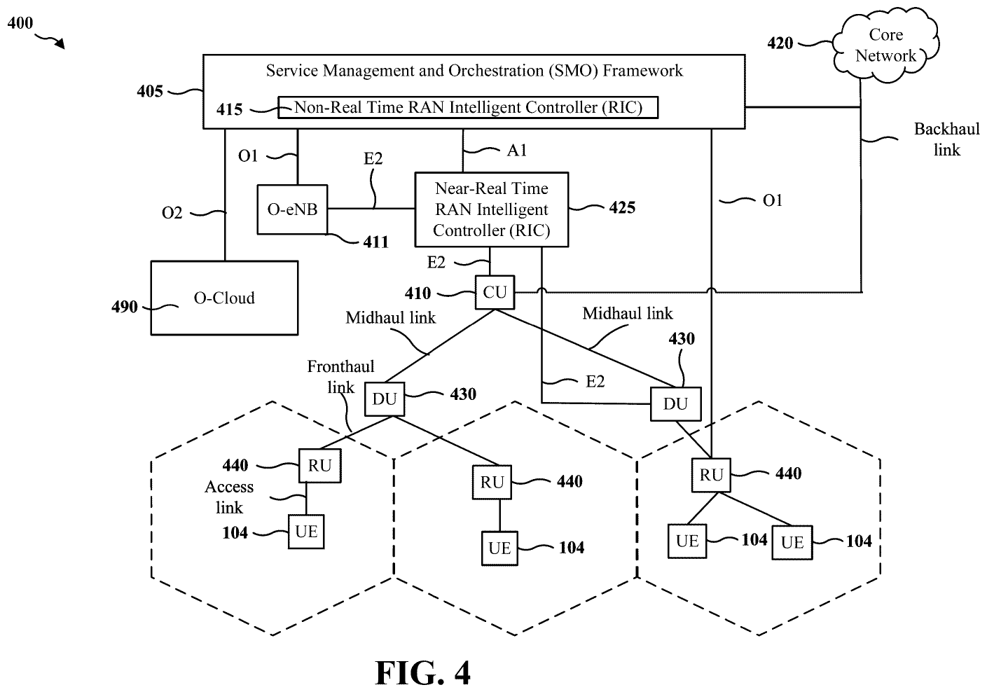

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/R U, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an AI interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

Examples of Adaptive Receive Diversity (ARD) Control based on Battery Status

In higher order receive diversity (HORxD) of a wireless node, multiple antennas may be used to receive copies of the same signal (e.g., with each copy corresponding to a different path) in which the wireless node processes each receiver path to increase the combined signal to noise ratio. On the transmitter side, a signal may be routed, for example, to one of two antennas or to one of four antennas for transmission. On the receiver side, for an example with four receive antennas, a controller configured to cause selection of the paths, via the at least one antenna diversity switch, may be configured to establish paths between four separate antennas each receiving one of four different copies of a wireless signal, and four respective modules each configured to process one of the four different copies of the wireless signal. In a MIMO system, multiple different antennas may be used by each of the transmitter and the receiver with spatial multiplexing, with each antenna using the same radio channel and carrying a different data stream.

Wireless nodes may include varying numbers of receive chains that may be used to receive signaling from a transmitter. For example, the wireless node may be configured with 2 receive antennas (2Rx), four receive antennas (4Rx), six receive antennas (6Rx), eight receive antennas (8Rx), and so on. By receiving signaling via a higher number of antennas, the wireless node may improve the quality of the received signal through techniques such as diversity reception, where the signal from the antenna with the strongest reception is used, or through more complex techniques such as MIMO where the signals from multiple antennas are combined to improve reception.

However, while modem performance at the wireless node may be enhanced by using a higher number of receive antennas, that enhanced modem performance may cause a significant power draw from the node's battery. Accordingly, wireless communications may be further enhanced by finding an optimal tradeoff between battery performance and modem performance.

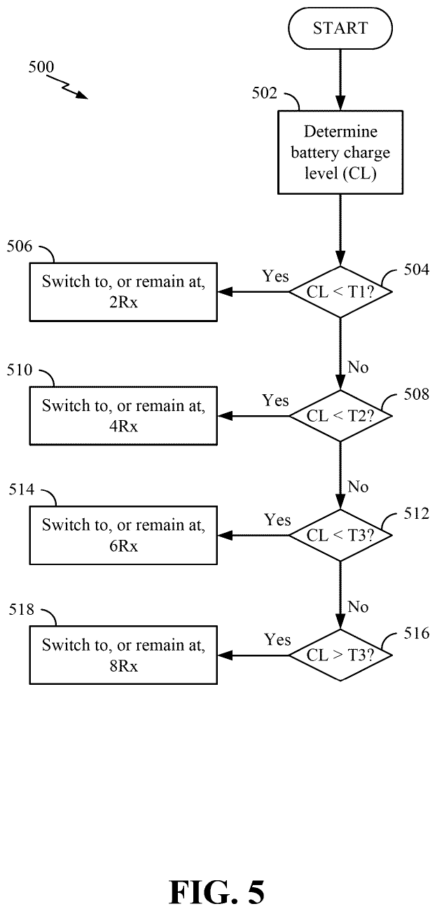

FIG. 5 is a flow diagram illustrating a first example process 500 for balancing battery performance and modem performance. At a first step 502, the wireless node may determine a charge level associated with a battery used to power the wireless node. In some examples, the wireless node may associate multiple indices with a charge level. For example, index T1 may correspond to a battery charge level of 2%, index T2 may correspond to a battery charge level of 10%, and index T3 may correspond to a battery charge level of 20%.

At a second step 504, the wireless node may determine whether the battery charge level is less than or equal to T1 (e.g., determine whether the battery charge level is equal to 2% or less). If yes, at a third step 506, the wireless node may switch to receiving signaling using two antennas (e.g., switch from 4Rx to 2Rx). If the wireless node is already using 2Rx, then the wireless node may determine to refrain from increasing the number of receive antennas to conserve battery power.

If the determination at the second step 504 is no, then at a fourth step 508, the wireless node may determine whether the battery charge level is less than or equal to T2 (e.g., determine whether the battery charge level is equal to 10% or between 10% and 2%). If yes, at a fifth step 510, the wireless node may switch to receiving signaling using four antennas (e.g., switch from 6Rx to 4Rx). If the wireless node is already using 4Rx, then the wireless node may determine to refrain from increasing the number of receive antennas to conserve battery power.

If the determination at the fourth step 508 is no, then at a sixth step 512, the wireless node may determine whether the battery charge level is less than or equal to T3 (e.g., determine whether the battery charge level is equal to 20% or between 20% and 10%). If yes, at a seventh step 514, the wireless node may switch to receiving signaling using six antennas (e.g., switch from 8Rx to 6Rx). If the wireless node is already using 6Rx, then the wireless node may determine to refrain from increasing the number of receive antennas to conserve battery power.

If the determination at the sixth step 512 is no, then at an eighth step 516, the wireless node may determine that the battery charge level is greater than or equal to T3 (e.g., the battery charge level is equal to 20% more). At a ninth step 518, the wireless node may determine that it may use a maximum number of receive antennas (e.g., switch from 4Rx to 8Rx).

Thus, as the charge level of a battery charge decreases, the wireless node may reduce the number of receive antenna it uses for receiving signaling so that battery power is conserved. Conversely, as the charge level of a battery charge increases, the wireless node may increase the number of receive antenna it uses for receiving signaling so that communication performance is enhanced.

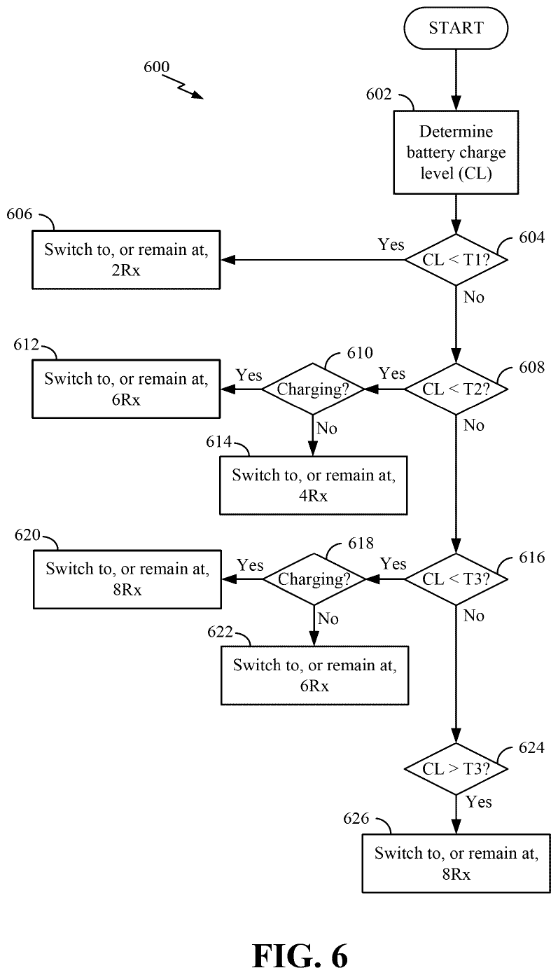

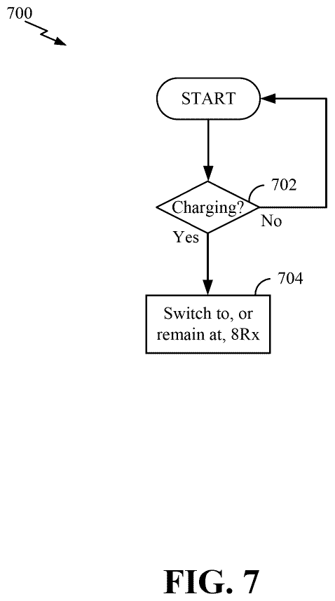

It should be noted that in the of FIG. 5 above, and FIGS. 6 and 7 below, the wireless node may gauge its battery charge level using any suitable number of indices and associated ranges of battery charge levels. Moreover, the number of receive antennas allowed with each determines index may be any number of antennas suitable for a particular wireless node.

Pseudo-code for first example process 500 is set forth below.

```
IF Battery_Level < T1 THEN
  MIMO_Capability = 2Rx
ELSE IF Battery_Level < T2 THEN
  MIMO_Capability <= 4Rx
ELSE IF Battery_Level < T3 THEN
  MIMO_Capability <= 6Rx
ELSE
  MIMO_Capability <= 8Rx
END IF
```

FIG. 6 is a flow diagram illustrating a second example process 600 for balancing battery performance and modem performance. At a first step 602, the wireless node may determine a charge level associated with a battery used to power the wireless node. As discussed above, the wireless node may associate multiple indices with a charge level.

At a second step 604, the wireless node may determine whether the battery charge level is less than or equal to T1. If yes, at a third step 606, the wireless node may switch to receiving signaling using two antennas (e.g., switch from 4Rx to 2Rx). If the wireless node is already using 2Rx, then the wireless node may determine to refrain from increasing the number of receive antennas to conserve battery power.

If the determination at the second step 604 is no, then at a fourth step 608, the wireless node may determine whether the battery charge level is less than or equal to T2 (e.g., determine whether the battery charge level is equal to 10% or between 10% and 2%). If yes, at a fifth step 610, the wireless node may determine whether the battery is currently being charged. If yes, then at a sixth step 612, the wireless node may switch to receiving signaling using six antennas (e.g., switch from 4Rx to 6Rx). If no, then at a seventh step, the wireless node may switch to receiving signaling using four antennas (e.g., switch from 6Rx to 4Rx). Accordingly, the number of antennas that the wireless node is allowed to use while its battery is at a particular charge level may depend on whether the battery is currently being charged or not.

If the determination at the fourth step 608 is no, then at an eighth step 616, the wireless node may determine whether the battery charge level is less than or equal to T3 (e.g., determine whether the battery charge level is equal to 20% or between 20% and 10%). If yes, at a ninth step 618, the wireless node may determine whether the battery is currently being charged. If yes, then at a tenth step 620, the wireless node may switch to receiving signaling using eight antennas (e.g., switch from 6Rx to 8Rx). If no, then at a ninth step 618, the wireless node may switch to receiving signaling using six antennas (e.g., switch from 8Rx to 6Rx).

If the determination at the eighth step 616 is no, then at a twelfth step 524, the wireless node may determine that the battery charge level is greater than or equal to T3 (e.g., the battery charge level is equal to 20% more). At a thirteen step 626, the wireless node may determine that it may use a maximum number of receive antennas (e.g., switch from 4Rx to 8Rx).

Thus, as the charge level of a battery charge decreases, the wireless node may reduce the number of receive antenna it uses for receiving signaling so that battery power is conserved. Conversely, as the charge level of a battery charge increases, the wireless node may increase the number of receive antenna it uses for receiving signaling so that communication performance is enhanced. However, if the wireless node is currently charging, then the number of receive antenna it can use may increase relative to the number of receive antenna associated with the same charge level if there is no charging.

Pseudo-code for second example process 600 is set forth below.

```
IF Battery_Level < T1 THEN
  MIMO_Capability = 2Rx
ELSE IF Battery_Level < T2 AND Battery_Charging_Status = TRUE THEN
  MIMO_Capability <= 6Rx
ELSE IF Battery_Level < T2 AND Battery_Charging_Status = FALSE THEN
  MIMO_Capability <= 4Rx
ELSE IF Battery_Level < T3 AND Battery_Charging_Status = TRUE THEN
  MIMO_Capability <= 8Rx
ELSE IF Battery_Level < T3 AND Battery_Charging_Status = FALSE THEN
  MIMO_Capability <= 6Rx
ELSE
  MIMO_Capability <= 8Rx
END IF
```

FIG. 7 is a flow diagram illustrating a third example process 700 for balancing battery performance and modem performance. At a first step 702, the wireless node may determine whether the wireless node is currently charging. If yes, at a second step 704, the wireless node may switch to a maximum number of receive antennas for receiving signaling.

In the examples described above in reference to FIGS. 5 and 6, it should be noted that the battery charge level and/or battery charging status may “allow” the wireless node to use a certain number of antennas for receiving a signal. However, the wireless node may refrain from using this certain number and instead use fewer antennas if the wireless node determines that no significant improvement in communication can be achieved by increasing the number of receive antennas to the allowed amount. For example, if a QoS metric is met by using 4Rx, but the battery charge level and/or battery charging status allows for 6Rx, the wireless node may continue to use 4Rx because the QoS metric is satisfied. Of course, any other suitable metric may be used to determine whether increasing the number of receive antennas at the wireless node would result in a significant improvement in communication.

However, in the example described in FIG. 7, the wireless node may switch to the maximum number of receive antennas regardless of whether any significant improvement can be achieved with a higher number of antennas.

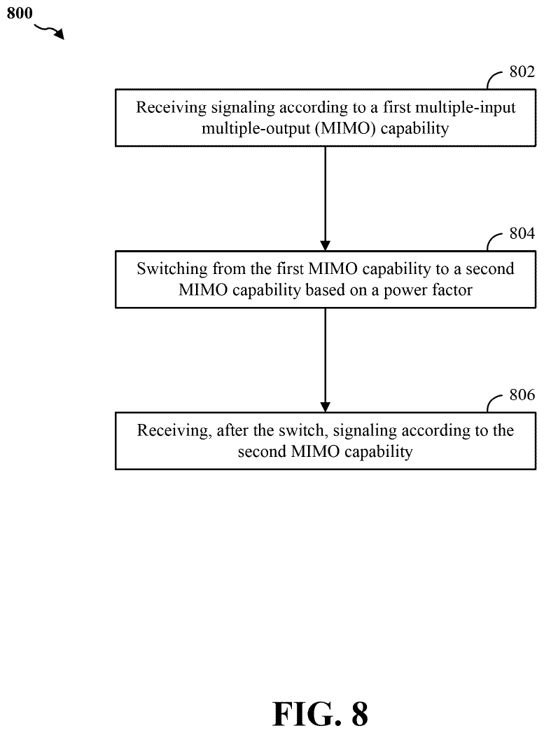

FIG. 8 is a flowchart 800 of a method of wireless communication. The method may be performed by a UE (e.g., the UE 104; the apparatus 902) or a network entity/base station (e.g., the base station 102/180; the apparatus 1002. Specifically, the method may be performed by one or more memories, processors, and RF front ends (e.g., the memory 360, controller/processor 359, transmitter 354TX, receiver 354RX, antenna 352, etc. of the UE illustrated in FIG. 3). Specifically, the method may be performed by one or more memories, processors, and RF front ends (e.g., the memory 376, controller/processor 375, transmitter 318TX, receiver 318RX, antenna 320, etc. of the network entity illustrated in FIG. 3).

At 802, the network node may receive signaling according to a first multiple-input multiple-output (MIMO) capability. For example, 902 may be performed by a receiving component 940/1040.

At 804, the wireless node may switch from the first MIMO capability to a second MIMO capability based on a power factor. For example, 804 may be performed by a switching component 942/1042.

Finally, at 806, the wireless node may receive, after the switch, signaling according to the second MIMO capability. For example, 806 may be performed by the receiving component 940/1040.

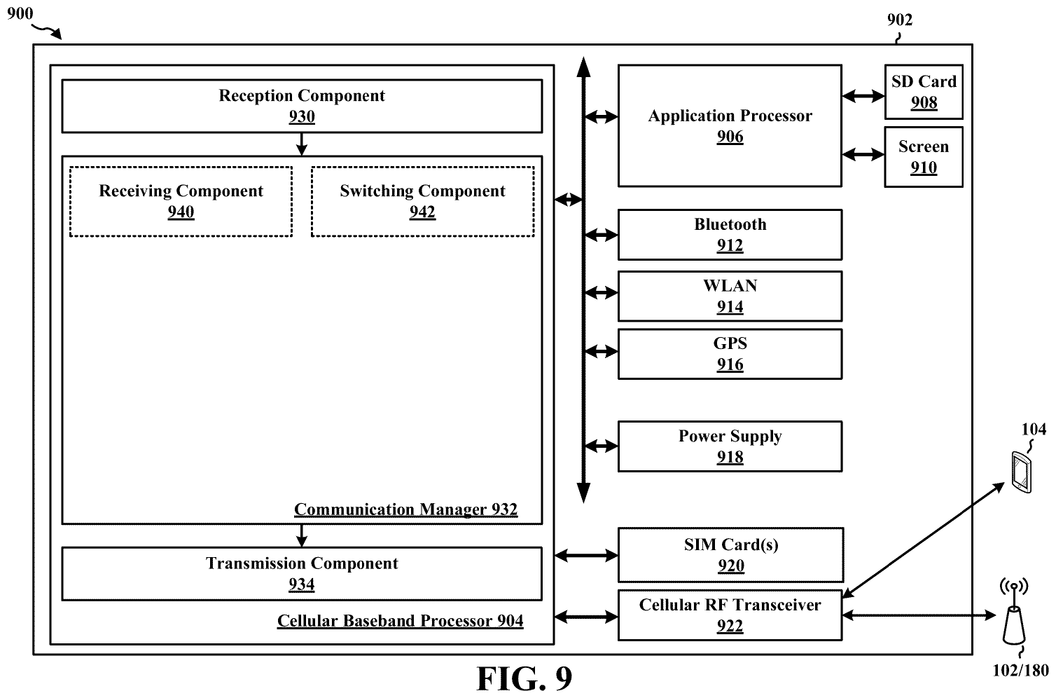

FIG. 9 is a diagram 900 illustrating an example of a hardware implementation for an apparatus 902. The apparatus 902 is a UE and includes a cellular baseband processor 904 (also referred to as a modem) coupled to one or more cellular RF transceivers 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The cellular baseband processor 904 communicates through the one or more cellular RF transceivers 922 with the UE 104 and/or B S 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 104 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see UE 104 of FIG. 3) and include the aforediscussed additional modules of the apparatus 902. In various examples, the apparatus 902 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 932 includes a receiving component 940 that is configured to: receiving signaling according to a first multiple-input multiple-output (MIMO) capability; and receive, after the switch, signaling according to the second MIMO capability; e.g., as described in connection with 802 and 806.

The communication manager 932 further includes a switching component 942 configured to switch from the first MIMO capability to a second MIMO capability based on a power factor, e.g., as described in connection with 804.

The apparatus may include additional components that perform each of the blocks of the algorithm in the aforementioned flowcharts of FIGS. 5-8. As such, each block in FIGS. 5-8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes: means for receiving signaling according to a first multiple-input multiple-output (MIMO) capability; means for switching from the first MIMO capability to a second MIMO capability based on a power factor; and means for receiving, after the switch, signaling according to the second MIMO capability. The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for selecting and means for generating may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

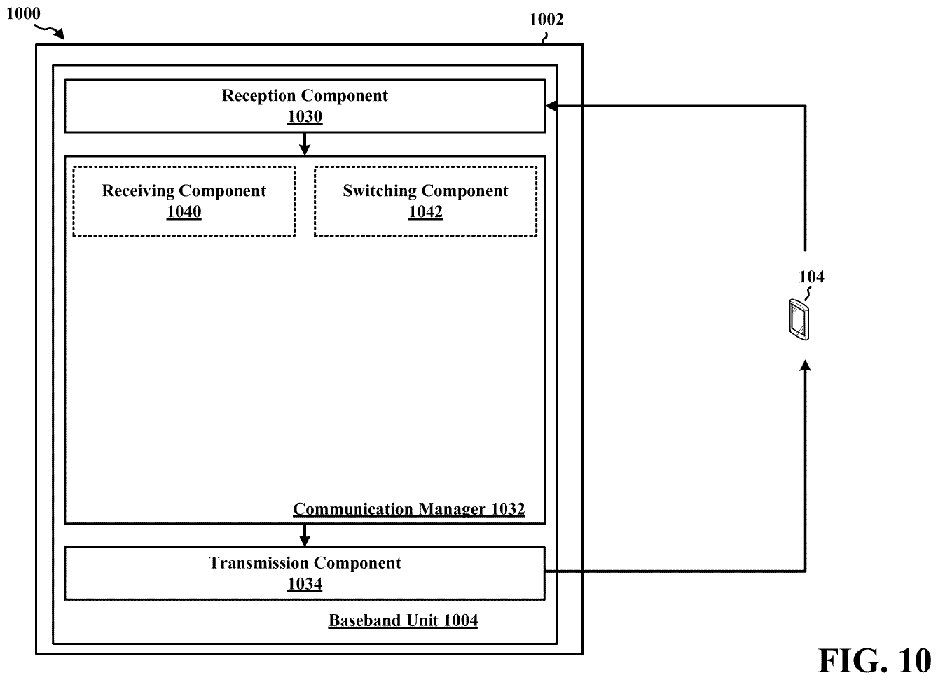

FIG. 10 is a diagram 1000 illustrating an example of a hardware implementation for an apparatus 1002. The apparatus 1002 is a BS and includes a baseband unit 1004. The baseband unit 1004 may communicate through one or more cellular RF transceivers with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes a receiving component 1040 configured to receive signaling according to a first multiple-input multiple-output (MIMO) capability; and receive, after the switch, signaling according to the second MIMO capability; e.g., as described in connection with 802 and 806. The communication manager 1032 further includes a switching component 1042 configured to switch from the first MIMO capability to a second MIMO capability based on a power factor; e.g., as described in connection with 804.

The apparatus may include additional components that perform each of the blocks of the algorithm in the aforementioned flowcharts of FIGS. 5-8. As such, each block in the aforementioned flowcharts of FIGS. 5-8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes: means for receiving signaling according to a first multiple-input multiple-output (MIMO) capability; means for switching from the first MIMO capability to a second MIMO capability based on a power factor; and means for receiving, after the switch, signaling according to the second MIMO capability. The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for selecting, means for detecting, means for determining, and means for generating may include a processing system, which may include one or more processors, such as the controller/processor 375, the memory 376, and/or any other suitable hardware components of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### ADDITIONAL CONSIDERATIONS

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at an apparatus, comprising: receiving signaling according to a first multiple-input multiple-output (MIMO) capability; switching from the first MIMO capability to a second MIMO capability based on a power factor; and receiving, after the switch, signaling according to the second MIMO capability.

Example 2 is the method of Example 1, wherein the first MIMO capability is configured to allow the apparatus to receive signaling via a first quantity of antennas, wherein the second MIMO capability is configured to allow the apparatus to receive signaling via a second quantity of antennas, and wherein the first quantity of antennas is different from the second quantity of antennas.

Example 3 is the method of any of Examples 1 and 2, wherein the power factor is associated with: (i) multiple charge levels of a battery including a first charge level and a second charge level, or (ii) an indication of whether the battery is currently being charged.

Example 4 is the method of Example 3, wherein the first charge level is associated with the first MIMO capability, and wherein the second charge level is associated with the second MIMO capability.

Example 5 is the method of any of Examples 3 and 4, wherein the switch from the first MIMO capability to the second MIMO capability is based on a charge level of the battery as it changes from the first charge level to the second charge level.

Example 6 is the method of any of Examples 3-5, wherein the method further comprises: detecting an imbalance between a first antenna and a second antenna, wherein the switch from the first MIMO capability to the second MIMO capability is based further on the imbalance satisfying a threshold condition.

Example 7 is the method of any of Examples 3-6, wherein if the power factor is indicative of the battery currently being charged, then the signaling received according to the second MIMO capability is received via a maximum quantity of antennas capable of receiving the signaling.

Example 8 is an apparatus for wireless communications, comprising means for performing a method in accordance with any one of examples 1-7.

Example 9 is a non-transitory computer-readable medium comprising instructions that, when executed by a wireless node, cause the wireless node to perform a method in accordance with any one of examples 1-7.

Example 10 is an apparatus for wireless communications, comprising: one or more memories, individually or in combination, having instructions; and one or more processors, individually or in combination, configured to execute the instructions to cause the apparatus to perform a method in accordance with any one of examples 1-7.

What is claimed is:

1. A wireless node configured for wireless communication, comprising:
a battery;
at least one transceiver;
one or more memories, individually or in combination, having instructions; and
one or more processors, individually or in combination, configured to execute the instructions to cause the wireless node to:
receive, via the at least one transceiver, signaling according to a first multiple-input multiple-output (MIMO) capability;
switch from the first MIMO capability to a second MIMO capability based on a power factor; and
receive, via the at least one transceiver after the switch, signaling according to the second MIMO capability.

2. The wireless node of claim 1, wherein the first MIMO capability is configured to allow the wireless node to receive signaling via a first quantity of antennas, wherein the second MIMO capability is configured to allow the wireless node to receive signaling via a second quantity of antennas, and wherein the first quantity of antennas is different from the second quantity of antennas.

3. The wireless node of claim 1, wherein the power factor is associated with: (i) multiple charge levels of the battery including a first charge level and a second charge level, or (ii) an indication of whether the battery is currently being charged.

4. The wireless node of claim 3, wherein the first charge level is associated with the first MIMO capability, and wherein the second charge level is associated with the second MIMO capability.

5. The wireless node of claim 3, wherein the switch from the first MIMO capability to the second MIMO capability is based on a charge level of the battery as it changes from the first charge level to the second charge level.

6. The wireless node of claim 5, wherein the one or more processors, individually or in combination, are further configured to cause the wireless node to:
detect an imbalance between a first antenna and a second antenna, wherein the switch from the first MIMO capability to the second MIMO capability is based further on the imbalance satisfying a threshold condition.

7. The wireless node of claim 3, wherein if the power factor is indicative of the battery currently being charged, then the signaling received according to the second MIMO capability is received via a maximum quantity of antennas capable of receiving the signaling.

8. A method for wireless communication at an apparatus, comprising:
receiving signaling according to a first multiple-input multiple-output (MIMO) capability;
switching from the first MIMO capability to a second MIMO capability based on a power factor; and
receiving, after the switch, signaling according to the second MIMO capability.

9. The method of claim 8, wherein the first MIMO capability is configured to allow the apparatus to receive signaling via a first quantity of antennas, wherein the second MIMO capability is configured to allow the apparatus to receive signaling via a second quantity of antennas, and wherein the first quantity of antennas is different from the second quantity of antennas.

10. The method of claim 8, wherein the power factor is associated with: (i) multiple charge levels of a battery including a first charge level and a second charge level, or (ii) an indication of whether the battery is currently being charged.

11. The method of claim 10, wherein the first charge level is associated with the first MIMO capability, and wherein the second charge level is associated with the second MIMO capability.

12. The method of claim 10, wherein the switch from the first MIMO capability to the second MIMO capability is based on a charge level of the battery as it changes from the first charge level to the second charge level.

13. The method of claim 12, wherein the method further comprises:
detecting an imbalance between a first antenna and a second antenna, wherein the switch from the first MIMO capability to the second MIMO capability is based further on the imbalance satisfying a threshold condition.

14. The method of claim 10, wherein if the power factor is indicative of the battery currently being charged, then the signaling received according to the second MIMO capability is received via a maximum quantity of antennas capable of receiving the signaling.

15. An apparatus, comprising:
means for receiving signaling according to a first multiple-input multiple-output (MIMO) capability;
means for switching from the first MIMO capability to a second MIMO capability based on a power factor; and
means for receiving, after the switch, signaling according to the second MIMO capability.

16. The apparatus of claim 15, wherein the first MIMO capability is configured to allow the apparatus to receive signaling via a first quantity of antennas, wherein the second MIMO capability is configured to allow the apparatus to receive signaling via a second quantity of antennas, and wherein the first quantity of antennas is different from the second quantity of antennas.

17. The apparatus of claim 15, wherein the power factor is associated with: (i) multiple charge levels of a battery including a first charge level and a second charge level, or (ii) an indication of whether the battery is currently being charged.

18. The apparatus of claim 17, wherein the first charge level is associated with the first MIMO capability, and wherein the second charge level is associated with the second MIMO capability.

19. The apparatus of claim 17, wherein the switch from the first MIMO capability to the second MIMO capability is based on a charge level of the battery as it changes from the first charge level to the second charge level.

20. The apparatus of claim 15, wherein if the power factor is indicative of a battery of the apparatus currently being charged, then the means for receiving signaling according to the second MIMO capability comprises a maximum quantity of antennas capable of receiving the signaling.
